(19) United States
(12) Patent Application Publication
(10) Pub. No.: US 2017/0004500 A1
(43) Pub. Date: Jan. 5, 2017

(54) Payment Transaction Processing Devices and Computer Implemented Payment Transaction Management Methods

(71) Applicant: comGateway (S) Pte Ltd, SINGAPORE (SG)

(72) Inventors: Kay Hian Lim, SINGAPORE (SG); Yirong Wee, SINGAPORE (SG); Paul Anthony Schmudde, El Segundo, CA (US)

(73) Assignee: comGateway (S) Pte Ltd, SINGAPORE (SG)

(21) Appl. No.: 14/869,786

(22) Filed: Sep. 29, 2015

(30) Foreign Application Priority Data
Jun. 30, 2015 (SG) 10201505213Q

(51) Int. Cl. G06Q 20/40; G06Q 20/34; G06Q 20/10

(52) U.S. Cl. CPC G06Q 20/405; G06Q 20/108; G06Q 20/34

(57) ABSTRACT

Payment transaction processing devices and computer implemented payment transaction management methods are described. According to one aspect, a payment transaction processing device includes communications circuitry configured to output and to receive communications with respect to the payment transaction processing device, storage circuitry comprising information regarding a plurality of payment cards, and processing circuitry configured to access a plurality of transaction specifications regarding a plurality of payment transactions, to access a plurality of transaction requests requesting a plurality of payments via the payment cards for respective ones of the payment transactions, to process information of the transaction requests with respect to information of the transaction specifications, to authorize some of the transaction requests which authorize payments from respective ones of the payment cards as a result of the processing, and to decline others of the transaction requests which decline payments from respective others of the payment cards as a result of the processing.

### TECHNICAL FIELD

This disclosure relates to payment transaction processing devices and computer implemented payment transaction management methods

### BACKGROUND OF THE DISCLOSURE

Fraudulent use of credit cards is of increasing concern, especially with the rising popularity of transactions via the Internet. While the Internet has accelerated the growth of card-not-present transactions, these transactions started originally with mail order/telephone orders or catalogue sales. Online fraud has escalated as the online industry has grown, and without any effective solutions in place, the problem will cost the market billions of dollars. Some security prevention strategies employed by the banks and card companies have been reactionary while the fraudsters on the other hand are becoming more sophisticated and their mining for card data from servers of merchants is yielding millions of sets of data every year. The data of stolen cards is then used or sold to syndicates to cheat the online industry for goods and cash. Syndicates that monetize stolen card data may be sophisticated and know how to target the weak links, such as merchants that are less protected.

Despite the security barriers which banks have erected to protect themselves and their card holders, great losses are incurred whether it be re-carding of customers with compromised card data or loss of confidence to transact online. Some proposed solutions have been complex requiring registration of card holders and implementation of the programs by many parties including issuing banks, the credit card scheme, and the acquirer banks. Solutions which are complex and dependent on broad implementation before they can be effective are difficult to get off the ground and may not achieve wide acceptance.

The credit card payment industry has been trying to manage the evolution of online payments since the introduction of online shopping. Online payments differ from offline payments principally as the card is not present compared with offline payments. The rules for offline transactions are generally that the issuer takes on the fraud risks if the card was used without the authorization of the legal card holder (e.g., a stolen card or a fraudulently replicated card used at a merchant store). The industry however has typically had different rules for card-not-present transactions. The rules provide that the fraud responsibility for a fraudulent payment is diverted to the acquiring bank and the acquiring bank subsequently passes the responsibility back to the merchant.

Physical cards have been more recently developed with additional security measures, for example the inclusion of smart chips, which has made the cards very difficult to copy and therefore enabled the industry to control and manage the fraud issue for card-present-transactions. However, there has not been similar success in finding an effective solution to manage fraud in online payments.

In particular, an unauthorized online payment may be attempted to made with the number of the credit card, expiry date of the card and perhaps a security code (e.g., CVV2 code), and which may be approved in many instances. The merchants bear any losses for fraud as the unauthorized charges are reversed to them and the merchants may be fined as well. Furthermore, issuing banks face card replacement costs if data of a card holder is compromised. Card holders are generally protected from authorized charges but they are responsible to report them. Some card holders may be apprehensive to use their cards out of fear that the cards may be used in unauthorized transactions.

At least some aspects of the disclosure are directed to systems and methods to reduce the occurrence of fraud and to increase security of payment transactions using payment cards, including online as well as offline transactions.

### BRIEF DESCRIPTION OF THE DRAWINGS

Example embodiments of the disclosure are described below with reference to the following accompanying drawings.

FIG. 1 is an illustrative representation of a plurality of entities of a payment transaction in one embodiment.

FIG. 2 is a functional block diagram of a computing device according to one embodiment.

FIG. 3 is a flow chart of a payment transaction initiated by a card holder according to one embodiment.

FIG. 4 is a flow chart of an authorization process of a payment transaction according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

At least some embodiments of the disclosure provide straightforward solutions for enhancing security of payment transactions involving payment cards (e.g., credit cards, debit cards, etc.). In one embodiment of the disclosure, the status of a payment card may be controlled to be either active where a payment transaction may be made using the card or inactive where a payment transaction may not be made using the card. At least some embodiments may be considered to build a switch into a payment card which allows the card to be active or inactive. A firewall is used to control the status of the payment card between active and inactive states according to some example embodiments of the disclosure which are described below.

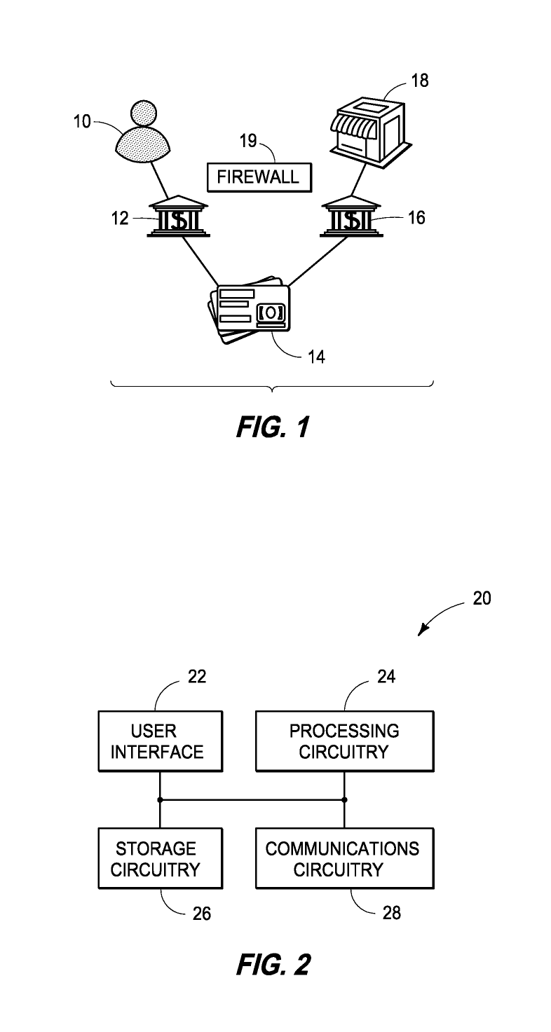

Referring to FIG. 1, an illustrative representation of a plurality of parties and their relationships is shown in a typical payment transaction involving payment cards. A card holder (also referred to as a user) 10 is associated with a payment card which may be used to purchase services and goods in a plurality of payment transactions. The payment card is issued by an issuing bank 12 where the card holder has an account. A card company or scheme 14 (e.g., VISA, MasterCard, etc.) manages payment transactions which involve the payment cards, for example including processing transactions and card information, issuing requests for payment approvals, authentication, receiving and paying funds with respect to banks, etc. Acquiring bank 16 is associated with a merchant 18 who offers goods or services for sale. In an example authorized payment transaction, funds for a purchase made by the card holder 10 of goods and/or services from merchant 18 are provided from the issuing bank 12 to the card company 14 to the acquiring bank 16 and ultimately to the merchant 18.

According to one embodiment described herein, a payment transaction processing device determines whether payment transactions are authorized or to be declined on an individual basis. In a more specific embodiment, the payment transaction processing device is implemented as a firewall 19 which is configured to implement security measures with respect to the payment transactions initiated by card holders. Firewall 19 processes information of the transactions and either authorizes or declines individual payment transactions as a result of the processing of the respective transactions in one embodiment.

As mentioned above, a payment card may be controlled to be active to allow payment transactions to be made via the card or inactive where payment transactions are not allowed to be made via the card. In one embodiment, a card holder may configure settings via the firewall 19 to control the status of their card as active or inactive at different moments in time with respect to different individual payment transactions to either allow or decline the payment transactions on an individual basis.

In one implementation, a default status of a payment card is inactive to not allow any payment transactions of any type to be made using the payment card unless authorized by the respective user (e.g., card holder). A user may access and control the firewall 19 to change the status of the payment card from inactive to active to allow one or more payment transactions to be made using the payment card in one embodiment.

According to one more specific embodiment, a payment card is inactive in a default mode for different types of payment transactions including offline (e.g., card-present transactions where the card is physically presented at a store and the card is processed with a Point of Sale (POS) terminal) as well as online transactions (e.g., card-not-present transactions, Mail Order Telephone Order mode transactions).

In other implementations, a card may have different default statuses with respect to different types of payment transactions. For example, existing payment card processing protocols identify different types of payment transactions, such as offline or online. In one embodiment, the payment card may have a default status of active for offline payment transactions and inactive for online payment transactions, and the type of the payment transaction may control the status of the payment card with respect to the individual payment transaction and whether user configuration of the firewall is needed to authorize a given payment transaction or not. In this example embodiment, all offline transactions made via the payment card would be authorized while online transactions would be authorized or declined in accordance with the settings of the firewall 19 with respect to the different online transactions. Different payment cards may be configured differently from one another and may have different security measures for different types of transactions in some arrangements.

Online payment transactions generally occur in three instances including initiation of the payment by the card holder, an authorized recurring payment transaction (e.g., a subscription) or unauthorized activity. One embodiment described below is configured to authorize the first two types of online payment transactions while declining the third type of payment transactions.

In one arrangement described in additional detail below, a user may forward a transaction specification to firewall 19 to configure firewall 19 to authorize a given transaction (either online or offline). As discussed below, the transaction specification defines values for one or more parameters which are used by the firewall 19 to authorize or decline a given transaction in one embodiment. Example parameters for a payment transaction include the name (and perhaps other information such as the website) of the merchant from which the goods and/or services are being purchased, a maximum or exact dollar amount, a date or time period in which the payment transaction is authorized, and type (e.g., recurring or one-time). Other parameters or criteria regarding the payment transaction may be processed or compared to determine whether to authorize a given payment transaction in other embodiments.

A merchant 14 receiving an order for goods and/or services from the cardholder 10 generates a payment request in order to determine whether the order is from an authorized payment card and should be fulfilled or whether the order is not from an authorized payment card and should be declined. The payment request defines values for one or more parameters which correspond to the parameters of the payment specifications (e.g., merchant name, amount, time period, and type). A transaction may be declined if values of any of the parameters of a transaction request for a given payment transaction do not match or correspond to the values of the parameters of the payment specification in one embodiment. Additional details of processing payment transactions by firewall 19 according to some embodiments are described below.

Referring to FIG. 2, an example computing device 20 is shown according to one embodiment. The depicted computing device 20 includes a user interface 22, processing circuitry 24, storage circuitry 26, and communications circuitry 28. Other embodiments are possible including more, less and/or alternative components.

User interface 22 is configured to interact with a user including conveying data to a user (e.g., displaying visual images for observation by the user) as well as receiving inputs from the user. User interface 12 is configured as graphical user interface (GUI) in one embodiment. User interface 12 may be configured differently in other embodiments.

In one embodiment, processing circuitry 24 is arranged to process data, control data access and storage, issue commands, and control other desired operations with respect to payment transactions. Processing circuitry 24 may comprise circuitry configured to implement desired programming provided by appropriate computer-readable storage media in at least one embodiment. For example, the processing circuitry 24 may be implemented as one or more processor(s) and/or other structure configured to execute executable instructions including, for example, software and/or firmware instructions. Other example embodiments of processing circuitry 24 include hardware logic, PGA, FPGA, ASIC, state machines, and/or other structures alone or in combination with one or more processor(s). These examples of processing circuitry 24 are for illustration and other configurations are possible.

Storage circuitry 26 is configured to store programming such as executable code or instructions (e.g., software and/or firmware), electronic data, databases, or other digital information and may include computer-readable storage media. For example, storage circuitry 26 may store information regarding one or more card holders, payment cards, payment transactions, etc. At least some embodiments or aspects described herein may be implemented using programming stored within one or more computer-readable storage medium of storage circuitry 26 and configured to control appropriate processing circuitry 24.

The computer-readable storage medium may be embodied in one or more articles of manufacture which can contain, store, or maintain programming, data and/or digital information for use by or in connection with an instruction execution system including processing circuitry 24 in one embodiment. For example, computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Communications circuitry 28 is arranged to implement communications of computing device 20 with respect to external devices (not shown). For example, communications circuitry 28 may be arranged to communicate information bi-directionally with respect to computing device 20. Communications circuitry 28 may be implemented as a network interface card (NIC), serial or parallel connection, USB port, Firewire interface, flash memory interface, wireless circuitry (e.g., Bluetooth, Cellular, GPS, Wi-Fi, etc.) or any other suitable arrangement for implementing communications with respect to computing device 20.

The illustrated configuration of computing device 20 may correspond to different computing devices utilized by the card holder 10, issuing bank 12, card company 14, acquiring bank 16 and merchant 18 to implement payment transactions in some embodiments. By way of further example, the computing device 20 of card holder 10 and merchant 18 may be a smart phone, tablet computer, notebook computer, etc. while the computing devices 20 of issuing bank 12, card company 14, acquiring bank 16 and firewall 19 may be servers. The computing devices 20 of the card holder 10, issuing bank 12, card company 14, acquiring bank 16, merchant 18 and firewall 19 may communicate with one another using an appropriate network, such as the Internet, in one embodiment.

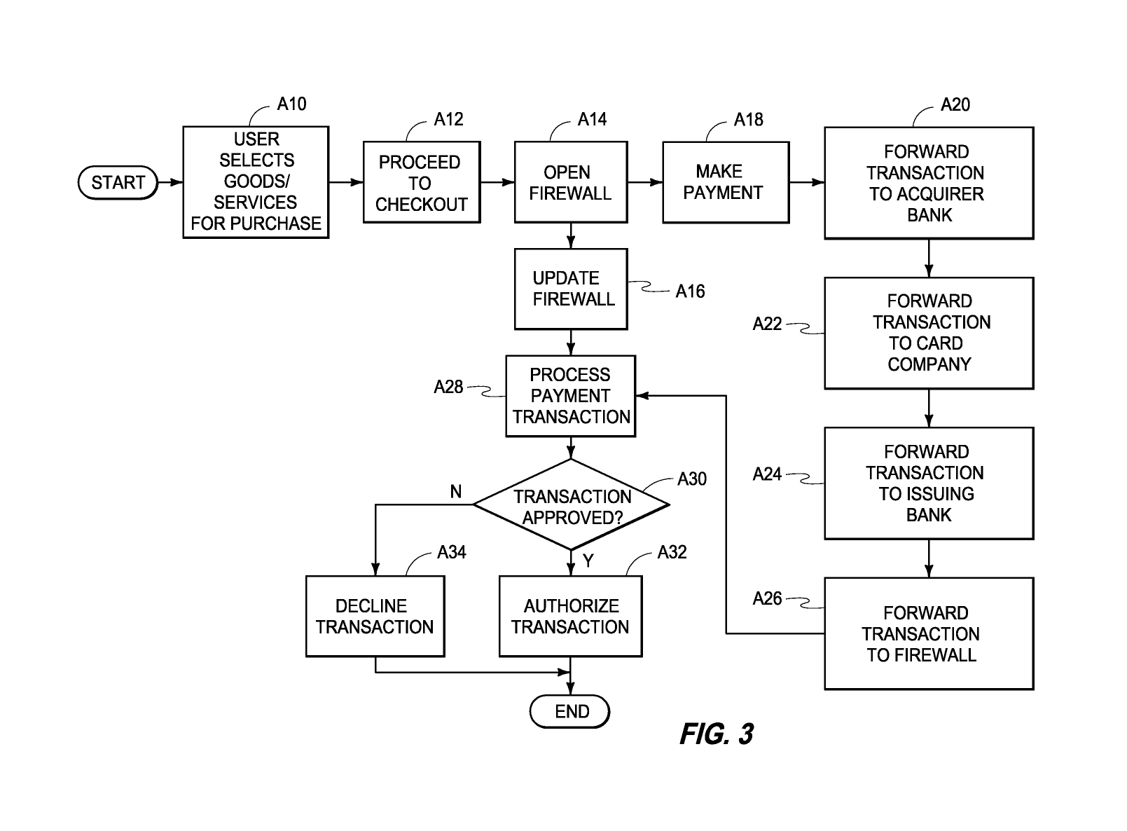

Referring to FIG. 3, is a flow chart of a payment transaction initiated by a card holder according to one embodiment. Other methods are possible including more, less and/or alternative acts. In addition, the acts may be performed in different orders in other embodiments.

Initially, at an act A10, a user selects goods and/or services for purchase while shopping. A selection may be made by the user offline at a point of sale (e.g., a card-present transaction at a physical merchant premises) or online, for example while browsing a web site of a merchant.

At an act A12, the user proceeds to checkout to pay for the selected goods and/or services.

At an act A14, the user accesses the firewall, for example, using a mobile device, home computer, etc.

At an act A16, the user updates settings of the firewall to authorize the payment transaction for the selected goods and/or services. In one embodiment, the user forwards a transaction specification regarding the purchase of the selected goods and/or services to update the firewall settings. The transaction specification authorizes payment to be made via the respective payment card for the respective payment transaction for the selected goods and/or services. A transaction specification may define one or more parameters for which the respective payment transaction is authorized and only a transaction request having one or more parameters which match or otherwise correspond to the parameters of the transaction specification are authorized. Example parameters for a payment transaction include name of the merchant, a maximum or exact dollar amount, a date or time period, and type (e.g., recurring or one-time) in one example embodiment as discussed above.

In one arrangement, a user may forward the transaction specification to the firewall by accessing a control panel of the firewall using a web application or mobile device application.

In one example web application implementation, a first factor authentication requiring a username (ID) and password may be used to control access to the firewall. In addition, a one-time user PIN code may be generated and communicated to a registered device of the user and which is then submitted to the firewall 19 for verification if a second factor authentication is desired and in accordance with one embodiment.

In some embodiments, the firewall 19 is resident at the issuing bank 12 or card company 14. The firewall 19 may issue a challenge requesting the appropriate PIN code from the user once the user attempts to access the firewall 19. In response, the user communicates the PIN code to the firewall 19 in order for the user to access, manage and/or control the firewall 19. If the PIN code provided by the user is determined to be correct, the user is permitted to access the firewall 19, otherwise the user is blocked from accessing the firewall 19. The firewall 19 or issuing bank 12 may generate and communicate the PIN code to the registered device of the user in some implementations.

In one example mobile device application, a user can authenticate access to the firewall 19 using biometric verification (e.g., fingerprint recognition or user identification and password). In addition, the physical control of the mobile device can be taken to be a second factor of authentication since a registered mobile device can be verified. These examples are illustrative and other methods for accessing the firewall 19 may be used in other embodiments.

At an act A18, the user attempts to make a payment via the payment card for the selected goods and/or services, for example, at a point of sale terminal at the merchant's physical premises or via the merchant's web site.

At an act A20, the merchant forwards a transaction request for the payment transaction to the acquiring bank which is associated with the merchant. The transaction request includes information of the parameters pertinent to the payment transaction in one embodiment.

At an act A22, the acquiring bank forwards the transaction request for the payment transaction to the card system which is associated with the payment card used by the user.

At an act A24, the card company forwards the transaction request for the payment transaction to the issuing bank which is associated with the payment card used by the user.

At an act A26, the issuing bank forwards the transaction request for the payment transaction to the firewall to determine whether the payment transaction is authorized or declined. In some embodiments, the firewall may be resident at the issuing bank or card company.

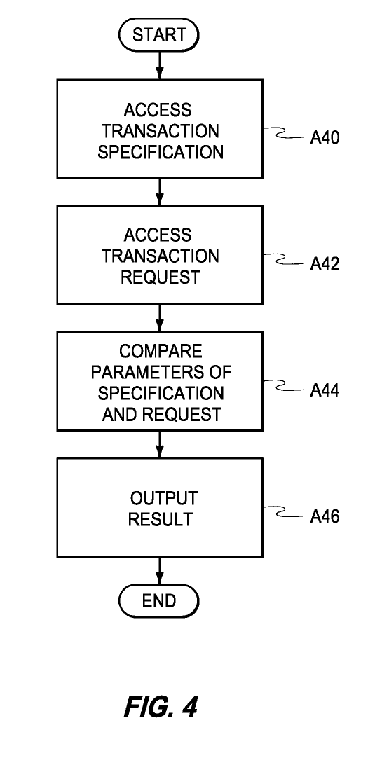

At an act A28, the firewall processes the transaction request with the transaction specifications. In one processing example, the firewall compares information regarding a plurality of parameters of the transaction request with respect to information regarding a plurality of parameters of one or more transaction specifications as discussed in additional detail below with respect to FIG. 4.

At an act A30, the firewall determines whether the payment transaction is approved/authorized or not as a result of the processing of act A28. The payment transaction is approved or authenticated if the information of the parameters of the transaction request correspond to or match one of the transaction specifications for the respective payment card of the card holder. Otherwise, the payment transaction is declined.

If the condition of act A30 is affirmative, the firewall proceeds to an act A32 to notify the issuing bank and merchant that the payment transaction is authorized and the issuing bank thereafter may transfer funds for the payment transaction to the card company, which forwards the funds to the acquiring bank and the merchant.

If the condition of act A30 is negative, the firewall notifies the card company and issuing bank that the payment transaction is not authorized and is declined and the issuing bank does not transfer funds for the declined payment transaction. The acquiring bank and merchant may also be notified that the payment transaction is not authorized and the attempted purchase by the user for the goods and/or services via the payment card may be declined.

Referring to FIG. 4, one method for processing a payment transaction is shown according to one embodiment. Other methods are possible including more, less and/or alternative acts. In addition, the acts may be performed in different orders in other embodiments. The method of FIG. 4 is executed by processing circuitry of the firewall in the described example implementation.

At an act A40, a transaction specification is accessed for a payment transaction. In one example mentioned above, the user may provide the transaction specification to the firewall during the purchase of desired goods and/or services. The transaction specification includes information regarding one or more parameters of the respective payment transaction, such as the merchant name, date of purchase or other period of time when the transaction specification is valid, amount of purchase and type of purchase (e.g., recurring payment or not) in one illustrative example.

The firewall may additionally receive a plurality of additional transaction specifications from the user with respect to the same payment card. In one embodiment, the firewall stores the transaction specifications for comparison with transaction requests which are received by the firewall to determine whether the corresponding payment transactions are authorized or not authorized.

At an act A42, a transaction request is accessed for the payment transaction. In one example mentioned above, the issuing bank provides the transaction request to the firewall as a result of the user attempting to purchase the goods and/or services using their payment card. The transaction request includes information regarding one or more parameters of the payment transaction which correspond to parameters of the transaction specification (e.g., merchant name, date, amount and type of purchase) in one embodiment.

At an act A44, the information regarding one or of the parameters within the transaction request is compared with the information regarding one or of the parameters within the transaction specification to determine whether the payment transaction corresponding to or otherwise defined in the transaction request is authorized by a respective transaction specification in one example processing embodiment. Information regarding only some of the parameters and/or information regarding other parameters may be compared in other processing embodiments.

In a more specific example implementation, and in order for the payment transaction to be authorized by the firewall, the information of the parameters of the transaction request match or correspond to the information of the parameters of one of the transaction specifications for the user of the payment card. In one more specific example of a transaction request matching one of the transaction specifications, the names of the merchants in the transaction request and specification correspond to one another, the amount in the transaction request is the same or less than the amount in the transaction specification, the date of purchase in the transaction request is the same as the purchase date or within the time period provided in the transaction specification, and the type of the payment transaction identified in the transaction request corresponds to the type of the payment transaction identified in the transaction specification. Other parameters or criteria regarding the payment transaction may be processed or compared in other embodiments. In addition, comparison of information regarding less than all of the parameters may be used to authorize or decline a payment transaction in other embodiments.

At an act A46, results of the processing of the transaction request with respect to the transaction specifications are outputted indicating whether the respective payment transaction is authorized or declined. The indication of whether the payment transaction is authorized or declined is sent to the merchant, acquiring bank, card company and issuing bank in one implementation, and the purchase is thereafter either authorized or declined in one embodiment. If the payment transaction is authorized, the merchant is notified to accept the payment and complete the purchase and the issuing bank provides appropriate funds for payment of the purchase to the card company which in turn provides the funds to the acquiring bank which in turn provides the funds to the merchant in one implementation. If the payment transaction is declined, a notice may be sent to the merchant to deny the payment transaction and corresponding pending sale.

The firewall may receive a plurality of transaction specifications from a given user in one embodiment. Upon receipt of a transaction request for a given user and payment card, the firewall may search existing transaction specifications for the given user and payment card to identify the appropriate transaction specification to be used for comparison purposes (e.g., matching merchants, dollar amounts and/or time periods). In one embodiments, information of the received transaction request may be processed with respect to all of the valid transaction specifications present within the firewall for the respective payment card to determine whether the payment transaction for the transaction request is valid. In some embodiments, the firewall is configured to only use transaction specifications which were received in the firewall before a given transaction request in order to determine whether the given transaction request should be authorized or declined.

At least some embodiments described herein are more straightforward compared to some conventional credit card security schemes, and additionally, do not require signification participation across the industry to reduce fraudulent transactions compared with some of the conventional approaches.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

1. A payment transaction processing device comprising:
communications circuitry configured to output and to receive communications with respect to the payment transaction processing device;
storage circuitry comprising information regarding a plurality of payment cards; and
processing circuitry configured to access a plurality of transaction specifications regarding a plurality of payment transactions, to access a plurality of transaction requests requesting a plurality of payments via the payment cards for respective ones of the payment transactions, to process information of the transaction requests with respect to information of the transaction specifications, to authorize some of the transaction requests which authorize payments from respective ones of the payment cards as a result of the processing, and to decline others of the transaction requests which decline payments from respective others of the payment cards as a result of the processing.

2. The device of claim 1 wherein the processing circuitry is configured to authorize the some of the transaction requests as a result of the some of the transaction requests being authorized by respective ones of the transaction specifications and the processing circuitry is configured to decline the others of the transaction requests as a result of the others of transaction requests not being authorized by respective ones of the transaction specifications.

3. The device of claim 1 wherein the processing circuitry is configured to compare information regarding one or more parameters of the transactions with information regarding one or more parameters of respective ones of the transaction specifications during the processing of the information, and to authorize the some of the transaction requests and to decline the others of the transaction requests as a result of the comparisons.

4. The device of claim 3 wherein the processing circuitry is configured to authorize the some of the transaction requests as a result of the parameters of the some of the transaction requests corresponding to the parameters of respective ones of the transaction specifications and to decline the others of the transaction requests as a result of the parameters of the others of the transaction requests not corresponding to the parameters of respective ones of the transaction specifications.

5. The device of claim 3 wherein the parameters of the transaction specifications define a plurality of time periods when respective ones of the transaction requests are authorized.

6. The device of claim 3 wherein the parameters of the transaction specifications define a plurality of payment amounts for respective ones of the transaction requests.

7. The device of claim 3 wherein the parameters of the transaction specifications define a plurality of merchants to which payments can be made for respective ones of the transaction requests.

8. The device of claim 7 wherein the parameters of the transaction specifications define whether respective ones of the transaction requests are recurring.

9. The device of claim 1 wherein the processing circuitry is configured to only authorize the transaction requests which are authorized by respective ones of the transaction specifications.

10. The device of claim 1 wherein the processing circuitry is configured to decline individual ones of the transaction requests unless the individual transaction requests are authorized by respective ones of the transaction specifications

11. The device of claim 1 wherein the processing circuitry is configured to authorize individual ones of the transaction requests only using transaction specifications which were received by the communications circuitry prior to the receipt of the respective ones of the transaction requests.

12. The device of claim 1 wherein the communications circuitry receives the transaction specifications from the users and the transaction requests from a plurality of issuing banks which are associated with the payment cards of the users.

13. The device of claim 1 wherein the payment transactions only comprise online transactions.

14. A computer implemented payment transaction management method comprising:
receiving a plurality of transaction specifications which authorize a plurality of respective payments via a plurality of respective payment cards for a plurality of respective payment transactions;
receiving a plurality of transaction requests which request the payments for the payment transactions using the payment cards;
authorizing some of the payments for some of the transaction requests using respective ones of the payment cards as a result of the some of the transaction requests being authorized by respective ones of the transaction specifications; and
declining others of the payments for others of the transaction requests as a result of the others of the transaction requests not being authorized by the transaction specifications.

15. The method of claim 14 further comprising comparing parameters of the transaction requests with parameters of respective ones of the transaction specifications, and wherein the authorizing and the declining comprises authorizing and declining as a result of the comparison.

16. The method of claim 15 wherein the authorizing comprises authorizing the some of the transaction requests as a result of the parameters of the some of the transaction requests corresponding to the parameters of respective ones of the transaction specifications and the declining comprises declining the others of the transaction requests as a result of the parameters of the others of the transaction requests not corresponding to the parameters of the transaction specifications.

17. The method of claim 14 wherein the authorizing comprises only authorizing the transaction requests which are authorized by respective ones of the transaction specifications.

18. The method of claim 14 wherein the declining comprises declining individual ones of the transaction requests unless the individual transaction requests are authorized by respective ones of the transaction specifications.

19. The method of claim 14 wherein the authorizing comprising authorizing individual ones of the transaction requests only using transaction specifications which were received prior to the receipt of the respective ones of the transaction requests.

20. The method of claim 14 wherein the receiving the transaction specifications comprises receiving the transaction specifications from the users and the receiving the transaction requests comprises receiving the transaction requests from a plurality of issuing banks which are associated with the payment cards of the users.

21. A non-transitory storage medium comprising programming configured to cause processing circuitry to perform the method of claim 14.

22. A computer implemented payment transaction management method comprising:
first receiving a plurality of transaction requests regarding a plurality of payment transactions for a plurality of payment cards;
after the first receiving, outputting information regarding individual ones of the payment transactions for the payment cards;
as a result of the outputting, second receiving a plurality of positive authorizations which indicate that some of the transaction requests are authorized and third receiving at least one negative authorization which indicates that at least one of the transaction requests is not authorized;
as a result of the receipt of the positive authorizations, transferring funds for a plurality of payments for respective ones of the some transaction requests which are authorized; and
as a result of the receipt of the at least one negative authorization, declining a transfer of funds for a payment for the at least one transaction request which is not authorized.

23. The method of claim 22 wherein the payment cards are associated with an issuing bank, and the first receiving, second receiving, third receiving, the outputting, the transferring and the declining comprise acts which are performed by the issuing bank.

24. A non-transitory storage medium comprising programming configured to cause processing circuitry to perform the method of claim 22.
